(19) United States
(12) Patent Application Publication
(10) Pub. No.: US 2025/0149269 A1
(43) Pub. Date: May 8, 2025

(54) Switching Apparatus

(71) Applicant: Alps Alpine Co., Ltd., Tokyo (JP)

(72) Inventor: Naoki HOSHI, Miyagi-ken (JP)

(21) Appl. No.: 19/010,345

(22) Filed: Jan. 6, 2025

Related U.S. Application Data
(63) Continuation of application No. PCT/JP2023/008047, filed on Mar. 3, 2023.

(30) Foreign Application Priority Data
Jul. 20, 2022 (JP) 2022-115454

(51) Int. Cl. H01H 13/32; H01H 5/06; H01H 13/78

(52) U.S. Cl. CPC H01H 13/32; H01H 5/06; H01H 13/78

(57) ABSTRACT

A switching apparatus includes a switching contact member, a common contact member, a movable contact member configured to electrically connect the switching contact member and the common contact member to each other, and a holding member that holds the movable contact member. The movable contact member includes a switching-side sliding-contact portion configured to come into sliding-contact with the switching contact member and a common-side elastic contact portion that is in elastic-contact with the common contact member. The holding member is rotatable about a rotation axis extending along a direction crossing an extending direction of the movable contact member. Rotation of the holding member allows switching between a first connection state and a second connection state. The rotation axis of the holding member passes through the common contact member, thereby enhancing the stability of conductivity at the operating fulcrum of the movable contact member.

### CLAIM OF PRIORITY

This application is a Continuation of International Application No. PCT/JP2023/008047 filed on Mar. 3, 2023, which claims benefit of Japanese Patent Application No. 2022-115454 filed on Jul. 20, 2022. The entire contents of each application noted above are hereby incorporated by reference.

### BACKGROUND OF THE INVENTION

### 1. Field of the Invention

The present invention relates to a switching apparatus.

### 2. Description of the Related Art

Japanese Unexamined Patent Application Publication No. 2016-157536 discloses a switch including a base, at least one switching device including at least one fixed contact point and provided at the base, a slider including a movable contact point that comes into contact with the fixed contact point and rotatably supported by the base, a cover attached to the base so as to cover the slider, a control lever rotatably supported by the base or the cover, and an elastic member which is connected to the slider and the control lever and urges the slider and the control lever in the drawing direction.

Since switching apparatuses switch between connection states by moving a movable contact member relative to a switching contact member, the operational reliability of the switching apparatuses depends on ensuring conductivity at the operating fulcrum of the movable contact member.

### SUMMARY OF THE INVENTION

The present invention provides a switching apparatus configured to enhance the stability of conductivity at the operating fulcrum of the movable contact member.

A switching apparatus according to an aspect of the present invention includes a switching contact member, a common contact member, a movable contact member disposed between the switching contact member and the common contact member and configured to electrically connect the switching contact member and the common contact member to each other, and a holding member that holds the movable contact member, wherein the movable contact member includes a switching-side sliding-contact portion configured to come into sliding-contact with the switching contact member and a common-side elastic contact portion that is in elastic-contact with the common contact member, wherein the holding member is rotatable about a rotation axis extending along a direction crossing an extending direction of the movable contact member, wherein rotating of the holding member allows switching between a first connection state and a second connection state, and wherein the rotation axis of the holding member passes through the common contact member.

With this configuration, as the rotation axis of the holding member passes through the common contact member, the sliding of the common-side elastic contact portion is reduced or suppressed, ensuring stable contact between the common contact member and the common-side elastic contact portion.

In the switching apparatus, the rotation axis of the holding member may pass through the common-side elastic contact portion. In this manner, as the rotation axis passes through not only the common contact member but also the common-side elastic contact portion, the destabilization of the contact state between the common-side elastic contact portion and the common contact member is minimized, even if vibrations, particularly vibrations along the extending direction of the holding member, occur in the movable contact member during the rotation of the holding member.

In the first connection state of the switching apparatus, when a direction along a moving direction of the movable contact member is defined as a first direction, a direction perpendicular to the first direction and along the extending direction of the movable contact member is defined as a second direction, and a direction perpendicular to both the first direction and the second direction and along the rotation axis is defined as a third direction, the common-side elastic contact portion may include a pair of clamping pieces arranged in the third direction so as to clamp the common contact member. Since the rotation axis extends along the third direction, the destabilization of the conduction between the common-side elastic contact portion and the common contact member is minimized, even if vibrations in the in-plane direction of plane including the first direction and the second direction, occur in the movable contact member. Furthermore, since the common-side elastic contact portion clamps the common contact member with the pair of clamping pieces arranged in the third direction, the destabilization of the conduction between the common-side elastic contact portion and the common contact member is minimized, even if vibrations in the third direction occur in the movable contact member.

In the switching apparatus, the rotation axis of the holding member may pass through at least one of the pair of clamping pieces. Since the rotation axis passes through the clamping piece in this manner, the destabilization of the contact state between the clamping piece and the common contact member is minimized, even if vibrations occur in the movable contact member during the rotation of the holding member. Of course, the contact state becomes more stable when the rotation axis passes through both of the clamping pieces.

In the switching apparatus, the holding member may hold a plurality of the movable contact members juxtaposed in the third direction. The configuration in which the holding member holds the plurality of movable contact members enhances the redundancy of the switching operation.

In the switching apparatus, the common contact member may be fixed to a case, and the rotation axis of the holding member may be established when a contact end provided on the holding member rotates while remaining in contact with a receiving portion of the case. With this configuration, since the contact portion defining the rotation axis is non-conductive, the conduction state is not affected even if vibrations occur at this contact portion.

In the switching apparatus, the switching contact member may include two contact points independent from each other, the first connection state may be a first conduction state in which one of the two contact points and the movable contact member are electrically connected, and the second connection state may be a second conduction state in which another of the two contact points and the movable contact member are electrically connected. This configuration allows for switching between the first conduction state and the second conduction state by switching the contact between the movable contact member and the two contact points.

The switching apparatus may further include a snap-action mechanism. With the snap-action mechanism, the movable contact member tends to vibrate relative to the common contact member at the snap action operation. Even in such cases, the vibrations are unlikely to affect the conduction state between the movable contact member and the common contact member.

In the switching apparatus, the first connection state may be a conduction state in which there is an electrical connection with a contact point provided on the movable contact member, and the second connection state may be a non-conduction state in which there is no electrical connection with the contact point. This configuration allows for switching between the conduction state and the non-conduction state.

### BRIEF DESCRIPTION OF THE DRAWINGS

FIG. 1 is an external perspective view of a switching apparatus according to an embodiment;

FIG. 2 is a side view of the switching apparatus according to an embodiment;

FIG. 3 is a plan view of the switching apparatus according to an embodiment;

FIG. 4 is an exploded perspective view of the switching apparatus according to an embodiment;

FIG. 5 is a perspective view of a holding member and a movable contact member;

FIG. 6 is a side view illustrating the operation of the movable contact member;

FIG. 7 is an enlarged side view of a common-side elastic contact portion;

FIG. 8 is an enlarged perspective view of the common-side elastic contact portion;

FIG. 9 is a partially sectional perspective view illustrating a contact end and a receiving portion;

FIG. 10 is an enlarged perspective view illustrating the contact end and the receiving portion;

FIG. 11 is a schematic diagram illustrating the operation of the switching apparatus;

FIG. 12 is a schematic diagram illustrating the operation of the switching apparatus;

FIG. 13 is a schematic diagram illustrating the operation of the switching apparatus;

FIG. 14 is a schematic diagram illustrating the operation of the switching apparatus;

FIG. 15 is a schematic diagram illustrating the operation of the switching apparatus;

FIG. 16 is a schematic diagram illustrating the operation of the switching apparatus;

FIG. 17 is a schematic diagram illustrating the operation of the switching apparatus;

FIG. 18 is a schematic diagram illustrating the operation of the switching apparatus;

FIG. 19 is a schematic diagram illustrating the operation of the switching apparatus;

FIG. 20 is a schematic diagram illustrating the operation of the switching apparatus;

FIG. 21 is a schematic diagram illustrating the operation of the switching apparatus; and

FIG. 22 is a schematic diagram illustrating the operation of the switching apparatus.

### DESCRIPTION OF THE PREFERRED EMBODIMENTS

Embodiments of the present invention will be described in detail hereinbelow with reference to the accompanying drawings. In the following description, like components are identified by the same reference signs, and the description of previously explained components will be omitted as appropriate.

### Outline of Switching Apparatus

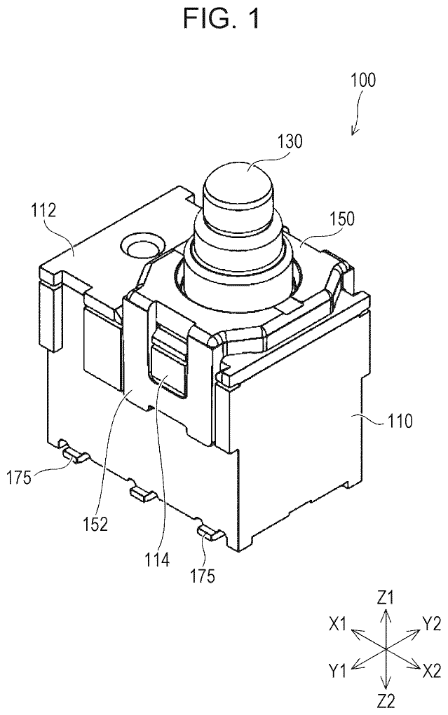

FIG. 1 is an external perspective view of a switching apparatus according to an embodiment.

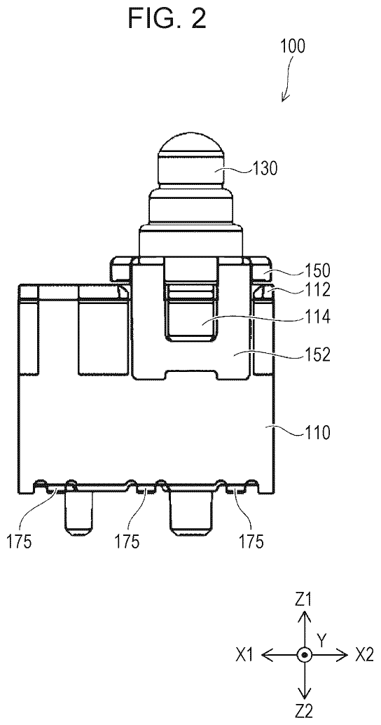

FIG. 2 is a side view of the switching apparatus according to an embodiment.

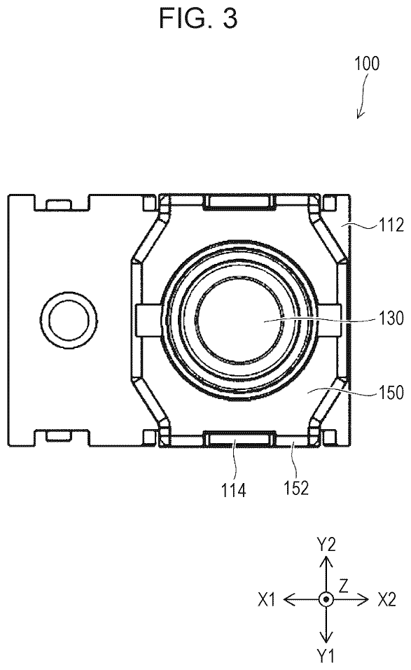

FIG. 3 is a plan view of the switching apparatus according to an embodiment.

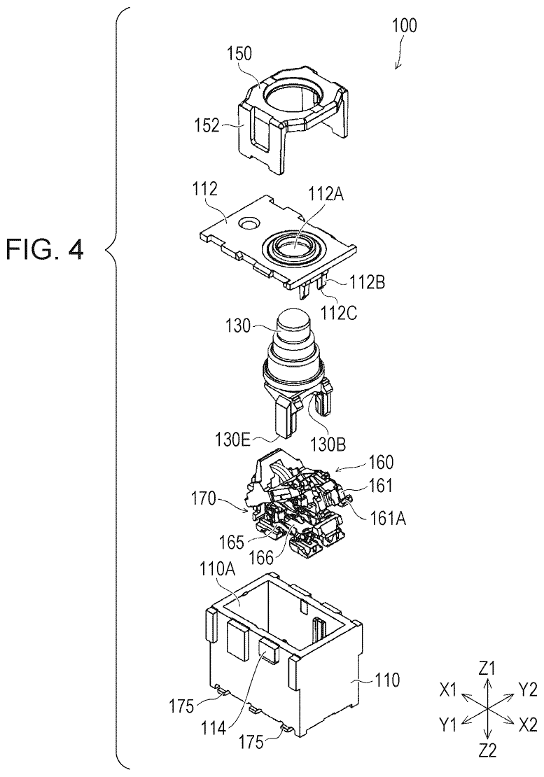

FIG. 4 is an exploded perspective view of the switching apparatus according to an embodiment.

In the following description, the Z1-22 direction in the drawings is defined as the Z-axis direction (vertical direction), the X1-X2 direction in the drawings is defined as the X-axis direction (front-back direction), and the Y1-Y2-direction in the drawings is defined as the Y-axis direction (lateral direction) for the sake of convenience. The Z-axis direction is defined as an example of “first direction”, the X-axis direction is defined as an example of “second direction”, and the Y-axis direction is defined as an example of “third direction”.

As illustrated in FIGS. 1 to 3, the switching apparatus 100 includes a case 110, a slider 130, and a holder 150. The case 110 has a hollow structure that is open at the top and has a rectangular parallelepiped shape. The upper opening of the case 110 is blocked by a planar cover 112.

As illustrated in FIG. 4, the cover 112 has a circular opening 112A through which the slider 130 is to be passed. The lower surface of the cover 112 is provided with columnar shafts 112B extending downward. The lower end of each shaft 112B is provided with a first shank 112C that has a downwardly curved, convex-shaped tip. The first shank 112C butts against the upper bearing surface 161A of a first actuator 161 of a movable unit 160 to rotatably support the first actuator 161 from above the first actuator 161.

The slider 130 is a generally cylindrical member designed to receive a pressing operation. The slider 130 passes through the opening 112A of the cover 112 and partially protrudes upward from the upper surface of the cover 112. The slider 130 is slidable on the case 110 in the vertical direction (Z-axis direction).

The switching apparatus 100 can switch the conduction state when the slider 130 is pressed. Specifically, the switching apparatus 100 is in a first connection state when the slider 130 is not pressed. When the switching apparatus 100 is pressed, the slider 130 switches to a second connection state. The first connection state may be a first conduction state, and the second connection state may be a second conduction state. The first connection state may be a conduction state, and the second connection state may be a non-conduction state.

The holder 150 is a ring-shaped member that covers the upper surface of the cover 112 and surrounds the slider 130. The holder 150 includes a pair of hooks 152 extending downward from the outer peripheral edge. The holder 150 is mounted on the case 110 when the pair of hooks 152 are individually engaged with a pair of tabs 114 provided on a pair of parallel sides of the case 110. Thus, the holder 150 fixes the cover 112 to the case 110. For example, the holder 150 is formed by processing a metal plate.

### Configuration of Switching Apparatus

The switching apparatus 100 includes the holder 150, the cover 112, the slider 130, the movable unit 160, and the case 110. In other words, the switching apparatus 100 includes the movable unit 160 illustrated in FIG. 4 in the case 110, in addition to the configuration illustrated in FIGS. 1 to 3.

The case 110 has a space 110A that is open at the top. The space 110A houses a lower part (on the Z2-side) of the slider 130 and the movable unit 160. For example, the case 110 is formed of a relatively hard insulating material (for example, a hard resin) using injection molding.

The movable unit 160 is composed of multiple movable parts. The movable unit 160 operates in conjunction with the vertical movement of the slider 130 caused by a pressing operation, thereby switching the switching apparatus 100 by snap action between the first connection state and the second connection state.

The movable unit 160 includes a switching contact member 170, a movable contact member 165, and a holding member 166.

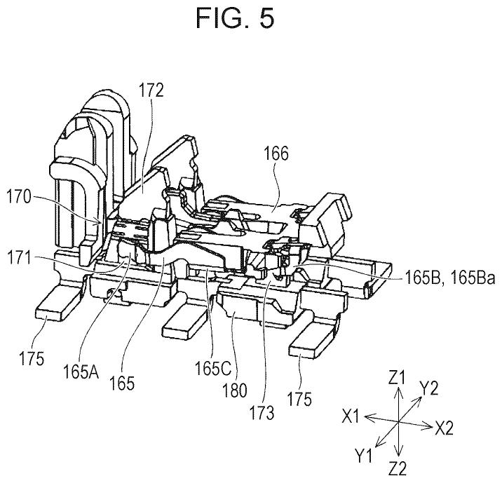

FIG. 5 is a perspective view of the holding member and the movable contact member.

As illustrated in FIG. 5, the movable contact member 165 and the holding member 166 are movable relative to the switching contact member 170. For example, the movable contact member 165 and the holding member 166 are supported by the case 110 so as to fluctuate and are slidable relative to the switching contact member 170 due to vertical movement caused by the pressing operation of the slider 130.

The base member 180 made of an insulating material includes at least two contact points (first contact points 171 and second contact points 172) of the switching contact member 170, a common contact member 173, and terminals 175. Each of the two contact points (the first contact points 171 and the second contact points 172) of the switching contact member 170 and the common contact member 173 is electrically connected to one of the multiple terminals 175. When the movable unit 160 is housed in the space 110A of the case 110, the multiple terminals 175 are exposed from the bottom of the case 110.

The movable contact member 165 is disposed between the switching contact member 170 and the common contact member 173 so as to allow for electrical connection between the switching contact member 170 and the common contact member 173. The two contact points (the first contact points 171 and the second contact points 172) of the switching contact member 170 are disposed away from each other in the Z-axis direction. By moving (for example, sliding) the movable contact member 165 in the Z-axis direction (the first direction) between the two contact points (the first contact points 171 and the second contact points 172), the electrical connection is switched between the common contact member 173 and one of the two contact points (the first contact points 171 and the second contact points 172).

For example, as illustrated in FIG. 5, when the movable contact member 165 is in contact with the first contact points 171, the first contact points 171 and the common contact member 173 are electrically connected via the movable contact member 165 into the first connection state. In contrast, when the movable contact member 165 is in contact with the second contact points 172, the second contact points 172 and the common contact member 173 are electrically connected via the movable contact member 165 into the second connection state. The connection state is switched through the up-and-down movement of the slider 130 caused by a pressing operation.

The movable contact member 165 that switches the connection state may be held by the holding member 166 made of an insulating material. The holding member 166 is supported by the case 110 so as to fluctuate. The oscillation causes the connection position of the movable contact member 165 relative to the switching contact member 170 to be switched.

The movable contact member 165 includes a main body 165C extending along the X-axis direction (the second direction), a switching-side sliding-contact portion 165A, and a common-side elastic contact portion 165B. The switching-side sliding-contact portion 165A is slidable relative to the switching contact member 170. The switching-side sliding-contact portion 165A includes a pair of contact pieces 165Aa. The pair of contact pieces 165Aa is provided at one end (on the X1 side in the X1-X2 direction) of the main body 165C, extends along the X-axis direction, and are juxtaposed in the Y-axis direction (the third direction) so as to clamp the switching contact member 170. The common-side elastic contact portion 165B comes into contact with the common contact member 173 and is disposed at a portion of the main body 165C different from the portion at which the pair of contact pieces 165Aa is disposed (for example, the other end (on the X2 side in the X1-X2 direction) of the main body 165C. The common-side elastic contact portion 165B may include a pair of clamping pieces 165Ba. The pair of clamping pieces 165Ba of the common-side elastic contact portion 165B are juxtaposed in the Y-axis direction so as to clamp the common contact member 173.

The movable contact member 165 is formed, for example, by pressing a metallic material with spring properties. The movable contact member 165 is configured as a separate component from the holding member 166 made of an insulating material and is combined with the holding member 166. Multiple movable contact members 165 may be attached to one holding member 166.

In this embodiment, two movable contact members 165 are juxtaposed in Y-axis direction on the holding member 166. Two switching contact members 170, two common contact members 173, and two terminals 175 are provided for each of the movable contact members 165. By providing two movable contact members 165 and so on for one holding member 166, the redundancy of the switching operation is enhanced. The number of movable contact members 165 and so on provided for one holding member 166 is not limited to two and may be one or three or more.

### Operation of Movable Contact Member

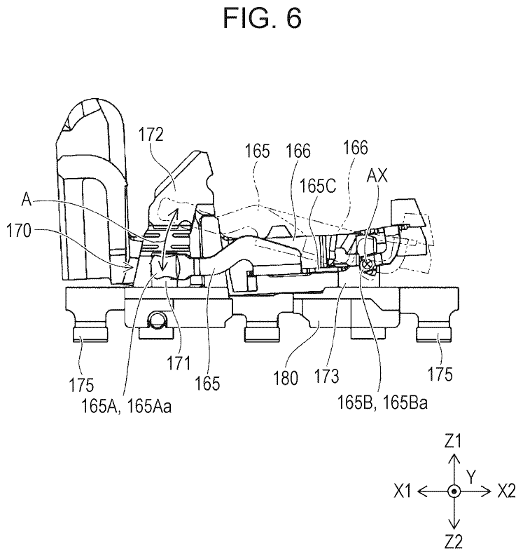

FIG. 6 is a side view illustrating the operation of the movable contact member.

FIG. 6 illustrates the base member 180, the switching contact member 170, the common contact member 173, the terminals 175, the movable contact member 165, and the holding member 166 for the convenience of description.

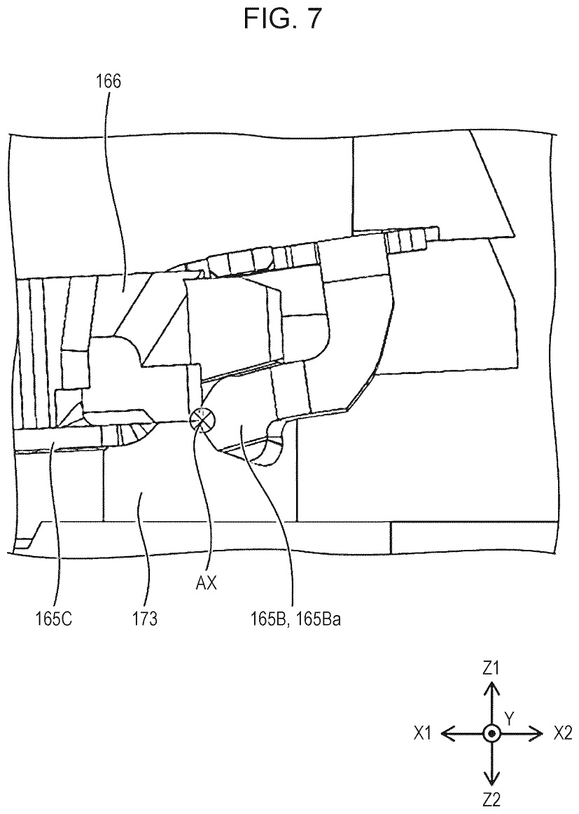

FIG. 7 is an enlarged side view of the common-side elastic contact portion.

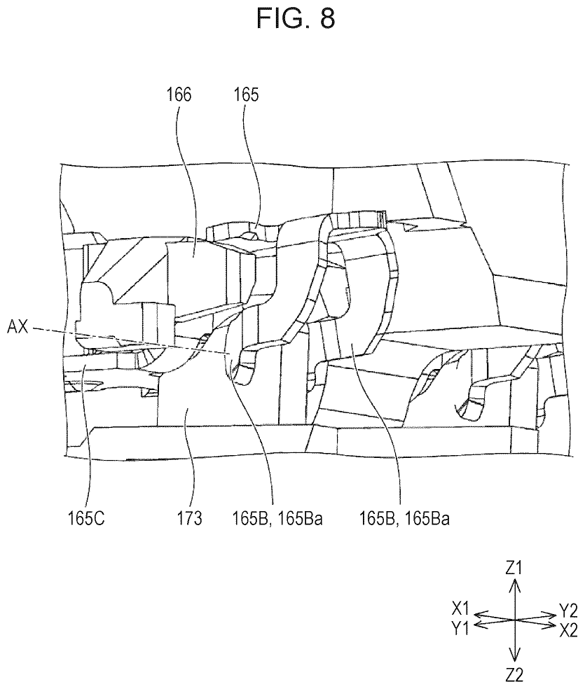

FIG. 8 is an enlarged perspective view of the common-side elastic contact portion.

The holding member 166 is rotatable about the Y-axis. The rotation of the holding member 166 causes the switching-side sliding-contact portion 165A of the movable contact member 165 to oscillate as indicated by arrow A in FIG. 6.

The pair of contact pieces 165Aa of the switching-side sliding-contact portion 165A clamps the switching contact member 170 from the opposite sides in the Y-direction to come into elastic-contact with the first contact point 171 or the second contact point 172 of the switching contact member 170. For this reason, the oscillation of the movable contact member 165 switches the connection position of the pair of contact pieces 165Aa while maintaining sliding-contact with the first contact point 171 or the second contact point 172. The connection between the pair of contact pieces 165Aa and the first contact point 171 assumes the first connection state; whereas the connection between the pair of contact pieces 165Aa and the second contact point 172 assumes the second connection state.

The common-side elastic contact portion 165B of the movable contact member 165 is in elastic-contact with the common contact member 173. In other words, the pair of clamping pieces 165Ba of the common-side elastic contact portion 165B clamps the common contact member 173 from the opposite sides in the Y-direction to come into elastic-contact with the common contact member 173. When the movable contact member 165 oscillates together with the rotation of the holding member 166 to switch between the first connection state and the second connection state, the elastic contact state between the common-side elastic contact portion 165B and the common contact member 173 is maintained.

The contact stability between the common-side elastic contact portion 165B and the common contact member 173 is susceptible to vibrations based on the movement of the movable contact member 165, in particular, vibrations along the direction in which the end of the common-side elastic contact portion 165B extends (that is, the extending direction (X-direction) of the movable contact member 165). With the configuration in which the common contact member 173 is clamped in the Y-direction (the direction perpendicular to the extending direction of the movable contact member 165) by the pair of clamping pieces 165Ba of the common-side elastic contact portion 165B, as in this embodiment, the contact between the common-side elastic contact portion 165B and the common contact member 173 can easily be maintained even if vibrations along the extending direction of the movable contact member 165 occur, enhancing the contact stability.

In the configuration in which the first connection state and the second connection state are switched, as above, the rotation axis AX of the holding member 166 is configured to pass through the common contact member 173. The rotation axis AX of the holding member 166 extends along the Y-axis. In this embodiment, the rotation axis AX overlaps with the common contact member 173 as seen in the Y-direction.

During the rotation of the holding member 166, the pair of clamping pieces 165Ba that clamps the common contact member 173 from the opposite sides in the Y-direction is in sliding-contact with the common contact member 173. Since the rotation axis AX of the holding member 166 passes through the common contact member 173, the sliding of the pair of clamping pieces 165Ba of the common-side elastic contact portion 165B relative to the common contact member 173 is reduced or minimized, allowing for stable contact between the common contact member 173 and the common-side elastic contact portion 165B.

More preferably, the rotation axis AX of the holding member 166 may pass through the common-side elastic contact portion 165B. Since the rotation axis AX passes through not only the common contact member 173 but also the common-side elastic contact portion 165B, the effectiveness of reducing and minimizing the sliding of the common-side elastic contact portion 165B during the rotation of the holding member 166 is enhanced. This reduces the destabilization of the contact state between the common-side elastic contact portion 165B and the common contact member 173, even when vibrations, particularly vibrations along the extending direction of the holding member 166, occur in the movable contact member 165.

Still more preferably, the rotation axis AX of the holding member 166 may pass through at least one of the pair of clamping pieces 165Ba of the common-side elastic contact portion 165B. Since the rotation axis AX passes through at least one of the pair of clamping pieces 165Ba, the sliding of at least one of the pair of clamping pieces 165Ba is reduced or minimized during the rotation of the holding member 166. This reduces the destabilization of the contact state between the pair of clamping pieces 165Ba and the common contact member 173, even when vibrations occur in the movable contact member 165. Greater stabilization is achieved when the rotation axis AX passes through both of the clamping pieces 165Ba.

Most preferably, the rotation axis AX of the holding member 166 may align with the contact point where the common contact member 173 is clamped by the pair of clamping pieces 165Ba of the common-side elastic contact portion 165B. This causes the movable contact member 165 to oscillate about the contact point between the pair of clamping pieces 165Ba and the common contact member 173 during the rotation of the holding member 166, thereby minimizing the sliding between the pair of clamping pieces 165Ba and the common contact member 173 to the greatest extent during the oscillation of the movable contact member 165.

### Contact End and Receiving Portion

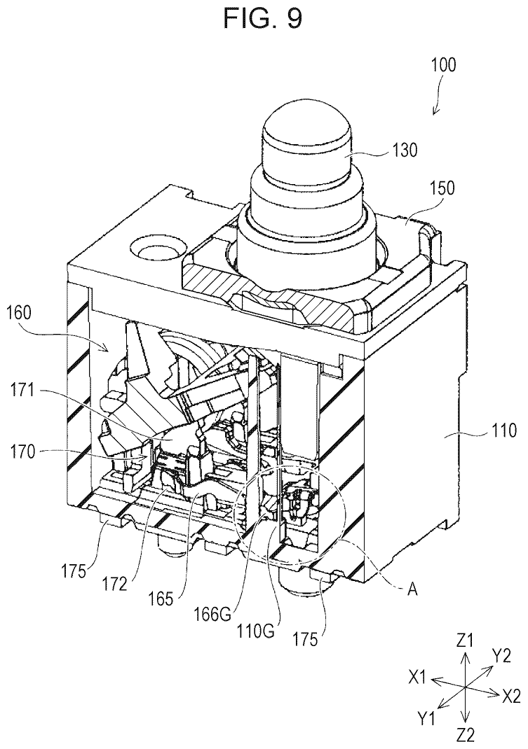

FIG. 9 is a partially sectional perspective view illustrating a contact end and a receiving portion.

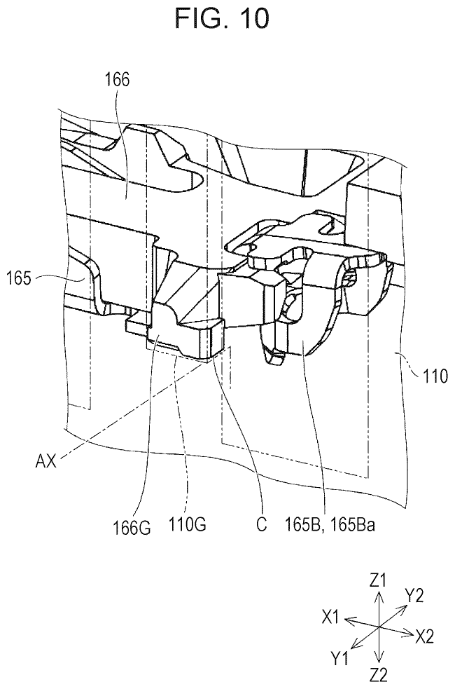

FIG. 10 is an enlarged perspective view illustrating the contact end and the receiving portion. FIG. 10 shows an enlarged view of part A in FIG. 9.

The common contact member 173 may be fixed to the case 110 via the base member 180. Contact ends 166G of the holding member 166 are accommodated within receiving portions 110G of the case 110. For example, the contact ends 166G are protrusions extending from the holding member 166 toward the opposite sides in the Y-direction, while the receiving portions 110G are recesses formed on the inner wall of the case 110 and extending in the Z-direction. When the movable unit 160 is housed in the space 110A of the case 110, the contact ends 166G are inserted into the receiving portions 110G in the Z-direction and seated on its bottom surface.

When the holding member 166 rotates, the contact end 166G and the receiving portion 110G remain in contact during the rotation. In other words, the contact portion C between each contact end 166G and each receiving portion 110G is on the rotation axis AX of the holding member 166. With this configuration in which the rotation axis AX is defined by the contact portion C between the contact end 166G of the holding member 166 and the receiving portion 110G of the case 110, the conduction state remains unaffected even if vibrations occur at the contact portion C, because the portion defining the rotation axis AX is non-conductive. This allows for stabilizing the conduction state even if vibrations occur. operation of Switching Apparatus

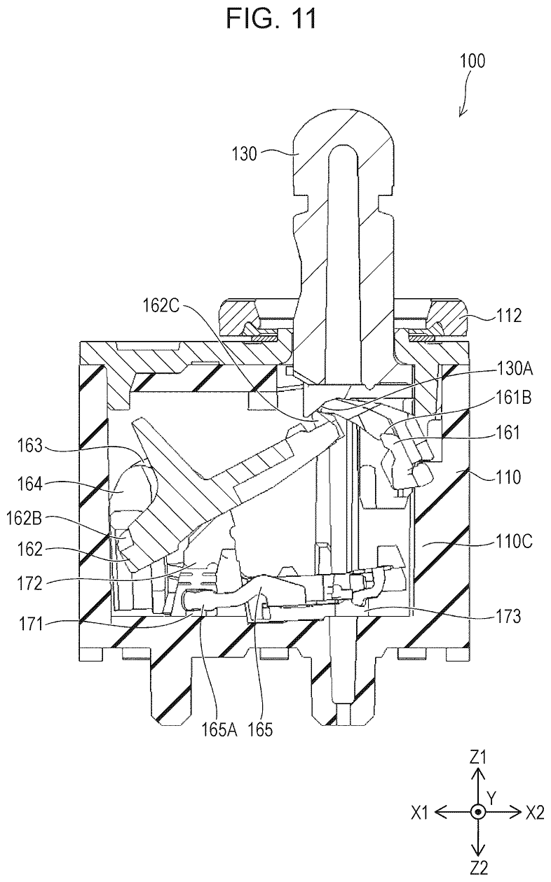

FIGS. 11 to 22 are schematic diagrams illustrating the operation of the switching apparatus.

### First State

FIG. 11 illustrates a state in which the slider 130 is not pressed (a first state). In the first state, a pressing surface 130A provided at the lower end of the slider 130 is in contact with a cam lobe 162C provided at an end of a cam 162. In this first state, the movable contact member 165, which is held by the holding member 166 serving as part of a second actuator 164, is in a horizontal state, the pair of contact pieces 165Aa of the switching-side sliding-contact portion 165A is in contact with the first contact point 171, and the pair of clamping pieces 165Ba of the common-side elastic contact portion 165B is in elastic-contact with the common contact member 173. In other words, the switching apparatus 100 is in the first connection state.

### Second State

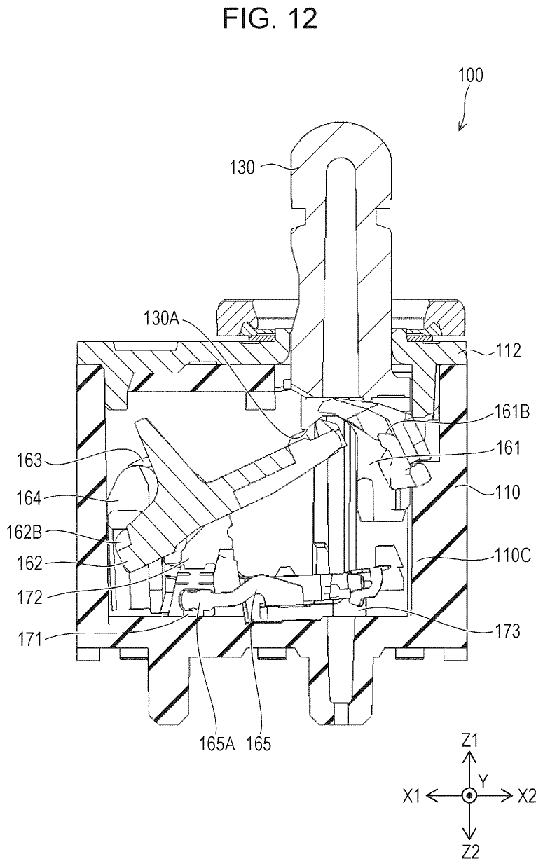

When the pressing operation of the slider 130 is started from the first state illustrated in FIG. 11, the pressing surface 130A of the slider 130 pushes the cam lobe 162C of the cam 162 downward, as illustrated in FIG. 12. This causes the cam 162 to start to rotate downward about a rotary shaft 162B journaled by a shaft 164A of the second actuator 164.

As illustrated in FIG. 12, when the slider 130 starts to slide downward, thereby slightly sliding downward, pressing portions 130B (see FIG. 4) at the opposite sides in the lateral direction (Y-axis direction) of the slider 130 come into contact with upper contact surfaces 161B at the opposite sides in the lateral direction (Y-axis direction) of the first actuator 161. This causes the slider 130 to start to push down the first actuator 161, in addition to pushing down the cam 162. Since the first actuator 161 is pushed down by the pressing portions 130B of the slider 130, the first actuator 161 starts to rotate downward about the first shanks 112C (see FIG. 4).

### Third State

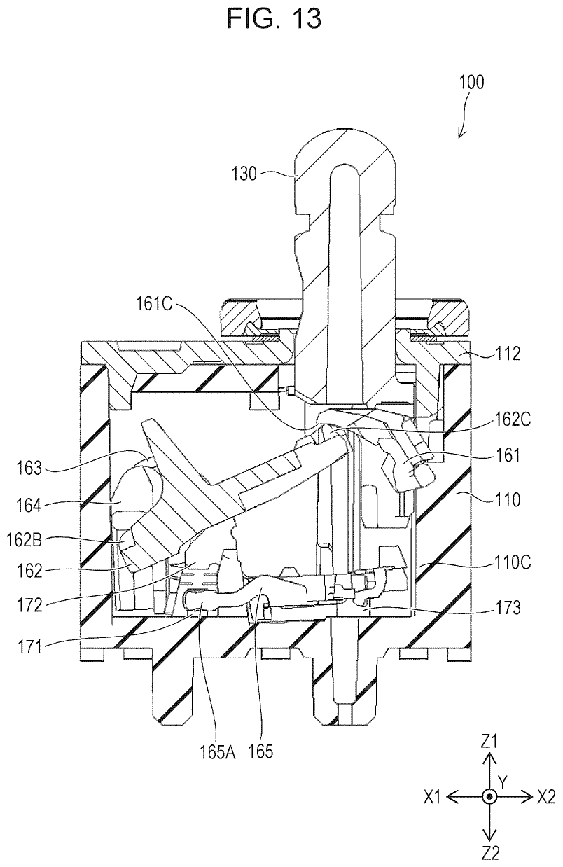

When the slider 130 further slightly slides downward from the second state illustrated in FIG. 12, a lower inclined surface 161C of the first actuator 161 comes into contact with the cam lobe 162C of the cam 162, as illustrated in FIG. 13. Thereafter, the cam lobe 162C of the cam 162 is separated from the pressing surface 130A of the slider 130 and is pushed down by the lower inclined surface 161C of the first actuator 161.

### Fourth State

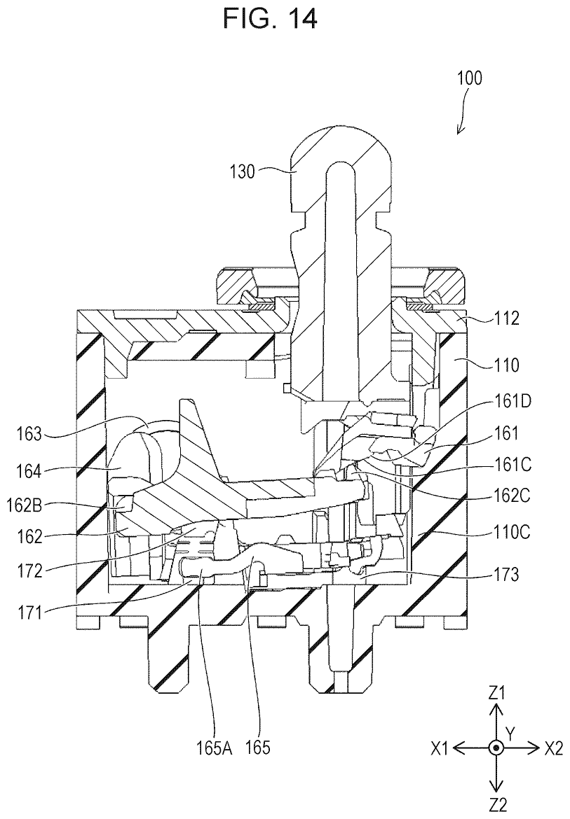

As illustrated in FIG. 14, when the first actuator 161 rotates downward to a predetermined angle, the rotation of the first actuator 161 is restricted. At this time, the force of the cam lobe 162C of the cam 162 moving to slide up the lower inclined surface 161C of the first actuator 161 due to the urging force from a torsion spring 163 exceeds the frictional resistance between the cam lobe 162C and the lower inclined surface 161C. This causes the cam lobe 162C to instantly slide up over the lower inclined surface 161C toward the top 161D of the lower inclined surface 161C to reach the top 161D and stops. On this occasion, since the top 161D has a gentle curved surface, the contact sound between the cam lobe 162C and the top 161D is suppressed.

### Fifth State

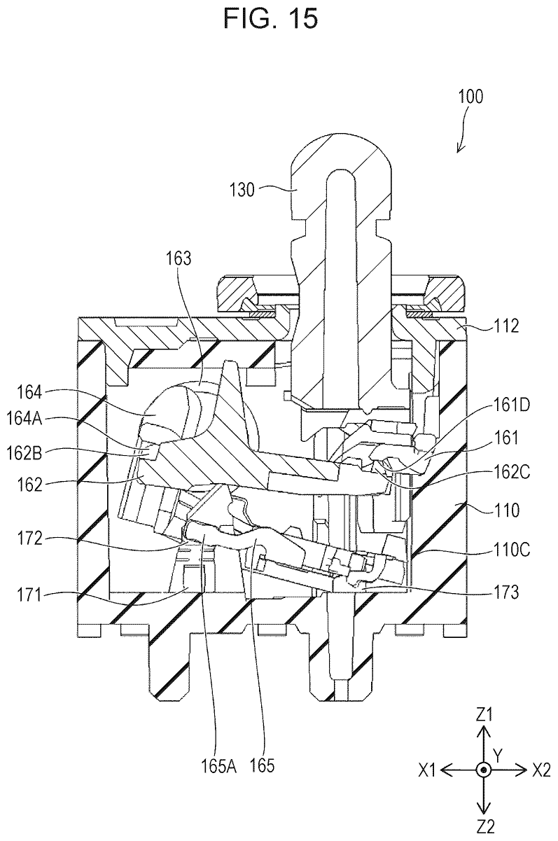

This causes the rotary shaft 162B of the cam 162 to instantly move up the shaft 164A of the second actuator 164, as illustrated in FIG. 15. At that time, the second actuator 164 rotates upward, using the contact point between the common-side elastic contact portion 165B of the movable contact member 165 held by the second actuator 164 and the common contact member 173 (for example, the contact point between the pair of clamping pieces 165Ba and the common contact member 173) as the rotation axis AX. This causes the contact positions of the pair of contact pieces 165Aa of the movable contact member 165 held by the second actuator 164 to be instantly switched from the first contact points 171 to the second contact points 172. As a result, the second contact points 172 and the common contact member 173 are electrically connected via the movable contact member 165, in other words, the switching apparatus 100 is switched to the second connection state. Thus, the switching apparatus 100 is capable of instant switching operation using a snap action.

### Sixth State

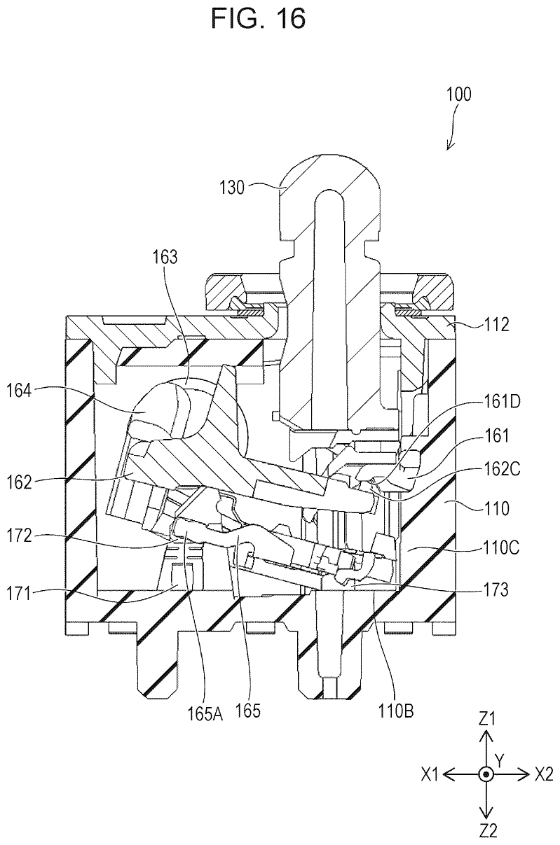

As illustrated in FIG. 16, when the slider 130 is further pushed down by overstroke in which the slider 130 is further pushed down after the switching operation, the first actuator 161 slides downward together with the slider 130 while pushing down the cam lobe 162C of the cam 162, with the rotation angle fixed. On this occasion, the slide of the first actuator 161 is guided by a guide rib 110C provided on the inner wall surface of the case 110 on the positive X-axis side. At that time, the first actuator 161 gradually comes away downward from the first shanks 112C of the cover 112 serving as its rotation center.

### Seventh State

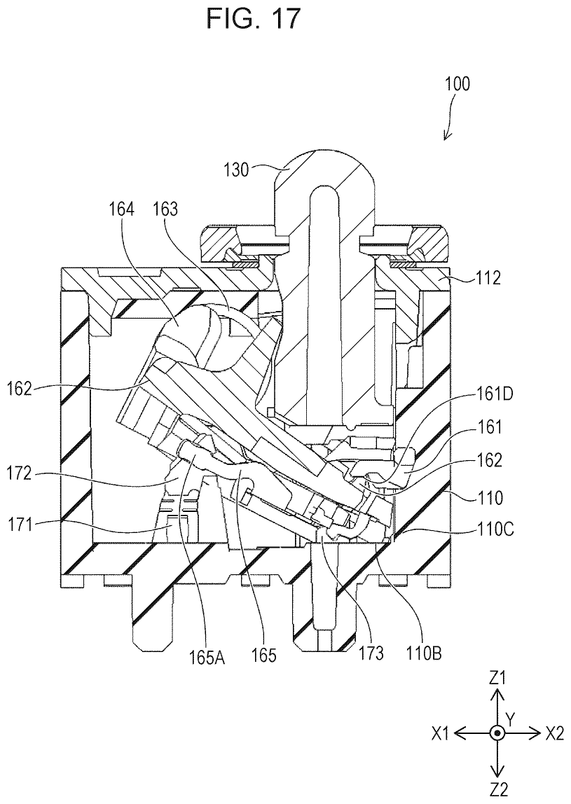

As illustrated in FIG. 17, when the slider 130 is pushed down until lower ends 130E of the slider 130 (see FIG. 4) and the bottom 110B of the case 110 come into contact, the downward slide of the slider 130 and the first actuator 161 stops. In other words, FIG. 17 illustrate a state in which the slider 130 is pushed downward most due to the overstroke of the slider 130.

When the pressing operation of the slider 130 is released thereafter, the slider 130 is pushed up by the cam 162 and the first actuator 161 due to the urging force from the torsion spring 163 to return to the initial position illustrated in FIG. 11.

### Eighth State

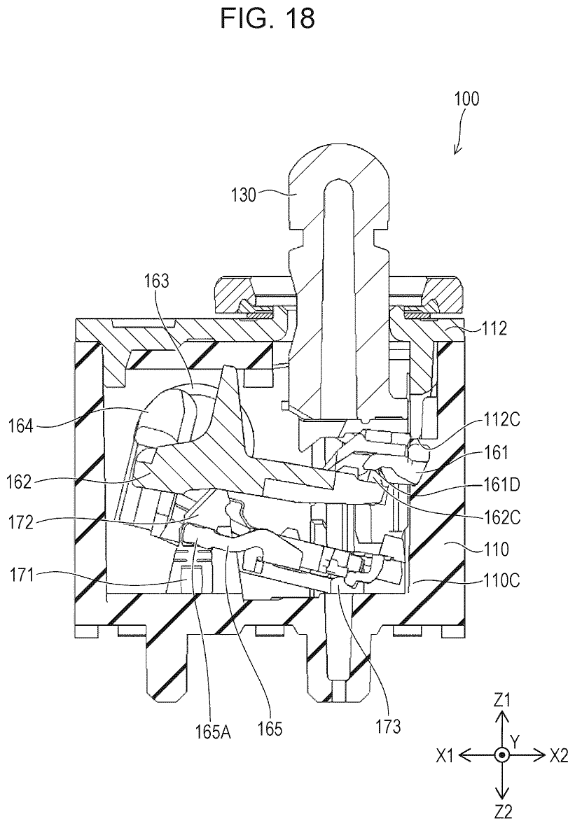

Specifically, as illustrated in FIG. 18, the cam lobe 162C of the cam 162 pushes the first actuator 161 upward using the urging force from the torsion spring 163 from the seventh state illustrated in FIG. 17. This causes the first actuator 161 to slide upward while pushing up the slider 130, with the rotation angle fixed. On this occasion, the slide of the first actuator 161 is guided by the guide rib 110C provided on the inner wall surface of the case 110 on the positive X-axis side. As illustrated in FIG. 18, when the first actuator 161 comes into contact with the first shanks 112C of the cover 112, the upward slide of the first actuator 161 stops.

### Ninth State

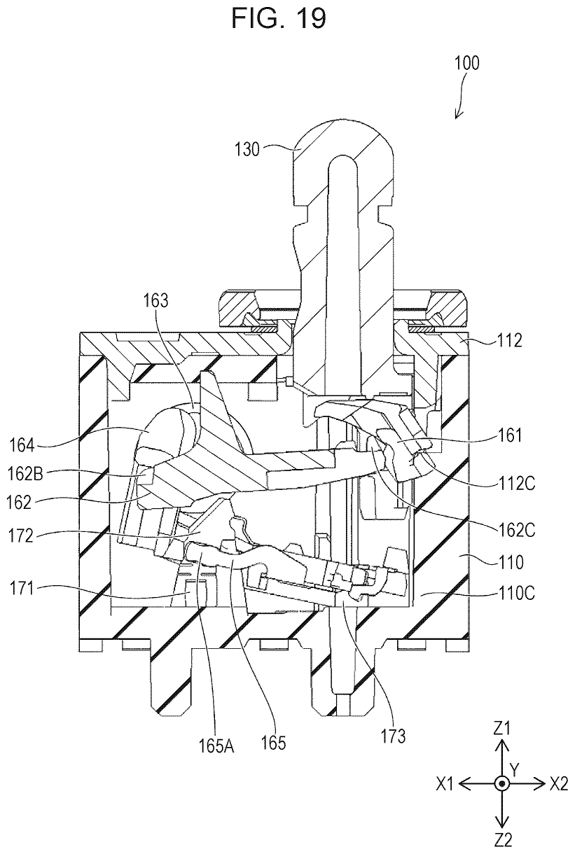

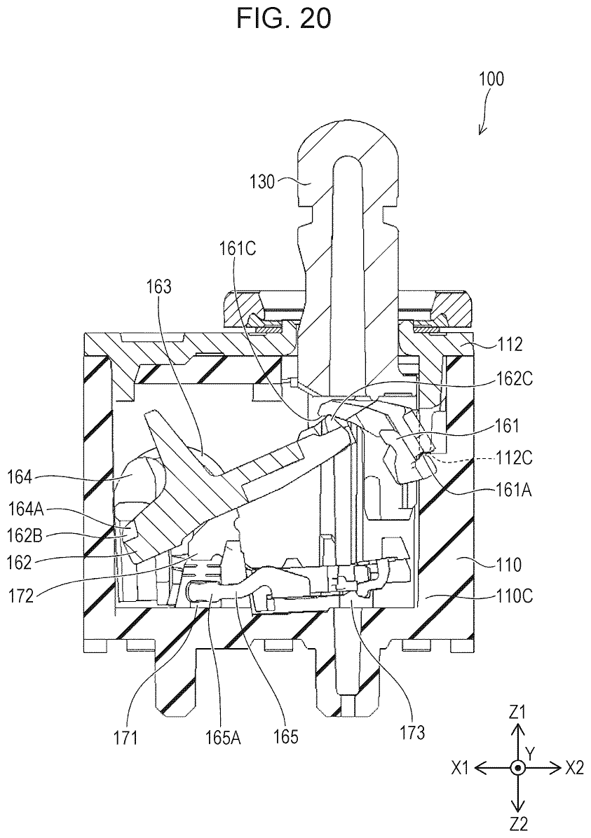

Thereafter, when the first actuator 161 is pushed up by the cam lobe 162C of the cam 162, as illustrated in FIG. 19, the first actuator 161 rotates upward while being journaled by the first shanks 112C of the cover 112 to push up the slider 130. The state in which the first actuator 161 is rotatably supported by the first shanks 112C of the cover 112 is illustrated in FIG. 20. The force of the cam lobe 162C of the cam 162 moving to slide up the lower inclined surface 161C of the first actuator 161 due to the urging force from the torsion spring 163 exceeds the frictional resistance between the cam lobe 162C and the lower inclined surface 161C. This causes the cam lobe 162C to instantly slide up over the lower inclined surface 161C toward the end of the lower inclined surface 161C. Consequently, the raising of the shaft 164A of the second actuator 164 by the rotary shaft 162B of the cam 162 is eliminated. In other words, the second actuator 164 instantly rotates downward using the contact point between the common-side elastic contact portion 165B of the movable contact member 165 and the common contact member 173 as the rotation axis AX.

### Tenth State

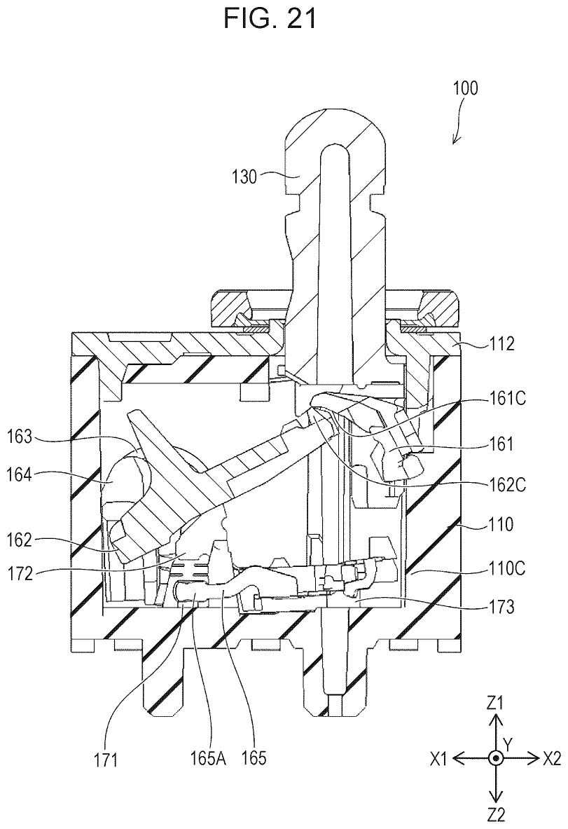

As illustrated in FIG. 21, when the second actuator 164 instantly rotates downward, the contact positions of the pair of contact pieces 165Aa of the movable contact member 165 held by the second actuator 164 instantly switch from the second contact points 172 to the first contact points 171. As a result, the first contact points 171 and the common contact member 173 are electrically connected via the movable contact member 165, in other words, the switching apparatus 100 is instantly switched to the first connection state. Thus, the switching apparatus 100, having a snap-action mechanism, enables instantaneous switching between the first connection state and the second connection state. When the contact position of the cam lobe 162C of the cam 162 switches from the lower inclined surface 161C of the first actuator 161 to the pressing surface 130A of the slider 130, as illustrated in FIG. 21, the upward rotation of the first actuator 161 ends, and the cam lobe 162C of the cam 162 urges the pressing surface 130A of the slider 130 upward to directly slide the slider 130 upward.

### Eleventh State

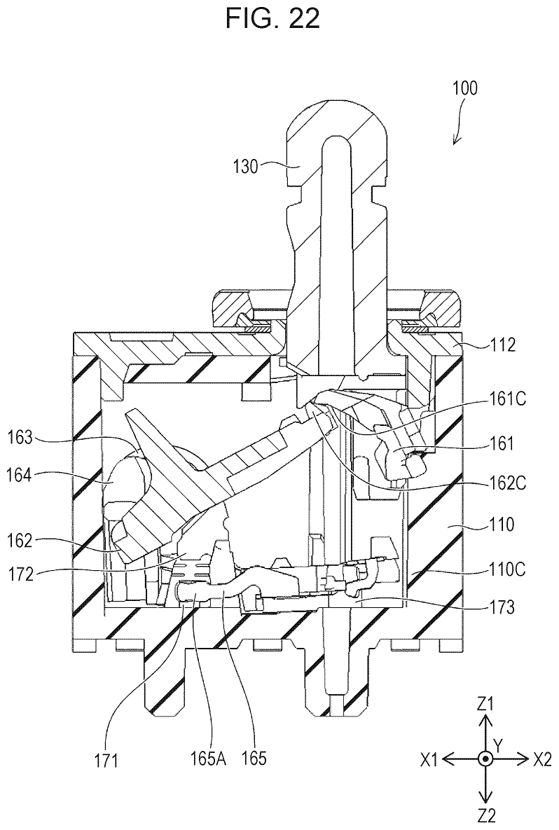

As illustrated in FIG. 22, when the slider 130 comes into contact with the lower surface of the cover 112, the upward slide of the slider 130 stops. In other words, FIG. 22 illustrates a state in which the slider 130 is pushed up most (the initial state).

This snap-action mechanism enables an instantaneous connection-state switching operation; however, at the snap action operation, the movable contact member 165 tends to vibrate relative to the common contact member 173. However, the configuration in which the rotation axis AX of the holding member 166 passes through the common contact member 173 may reduce the sliding of the common-side elastic contact portion 165B of the movable contact member 165 relative to the common contact member 173. Therefore, this reduces the impact of vibrations on the conduction state between the common-side elastic contact portion 165B and the common contact member 173, thereby stabilizing the contact between the common-side elastic contact portion 165B and the common contact member 173.

According to the embodiments, a switching apparatus 100 configured to enhance the stability of conductivity at the operating fulcrum of the movable contact member 165 may be provided.

Having described the embodiments, it is to be understood that the present invention is not limited to the above examples. It is to be understood that, for example, addition, deletion, or design changes of components performed by those skilled in the art on the above embodiments, as well as appropriate combinations of the features of the configurations of the embodiments, are also included within the scope of the present invention as long as they fall within the gist of the present invention.

What is claimed is:

1. A switching apparatus comprising:
a switching contact member;
a common contact member;
a movable contact member disposed between the switching contact member and the common contact member and configured to electrically connect the switching contact member and the common contact member to each other; and
a holding member that holds the movable contact member,
wherein the movable contact member includes a switching-side sliding-contact portion configured to come into sliding-contact with the switching contact member and a common-side elastic contact portion that is in elastic-contact with the common contact member,
wherein the holding member is rotatable about a rotation axis extending along a direction crossing an extending direction of the movable contact member,
wherein rotation of the holding member allows switching between a first connection state and a second connection state, and
wherein the rotation axis of the holding member passes through the common contact member.

2. The switching apparatus according to claim 1, wherein the rotation axis of the holding member passes through the common-side elastic contact portion.

3. The switching apparatus according to claim 1,
wherein, in the first connection state, when a direction along a moving direction of the movable contact member is defined as a first direction, a direction perpendicular to the first direction and along the extending direction of the movable contact member is defined as a second direction, and a direction perpendicular to both the first direction and the second direction and along the rotation axis is defined as a third direction,
the common-side elastic contact portion includes a pair of clamping pieces arranged in the third direction so as to clamp the common contact member.

4. The switching apparatus according to claim 3, wherein the rotation axis of the holding member passes through at least one of the pair of clamping pieces.

5. The switching apparatus according to claim 3, wherein the holding member holds a plurality of the movable contact members juxtaposed in the third direction.

6. The switching apparatus according to claim 1,
wherein the common contact member is fixed to a case, and
wherein the rotation axis of the holding member is established when a contact end provided on the holding member rotates while remaining in contact with a receiving portion of the case.

7. The switching apparatus according to claim 1,
wherein the switching contact member includes two contact points independent from each other,
wherein the first connection state is a first conduction state in which one of the two contact points and the movable contact member are electrically connected, and
wherein the second connection state is a second conduction state in which another of the two contact points and the movable contact member are electrically connected.

8. The switching apparatus according to claim 7, further comprising a snap-action mechanism.

9. The switching apparatus according to claim 1,
wherein the first connection state is a conduction state in which there is an electrical connection with a contact point provided on the movable contact member, and
wherein the second connection state is a non-conduction state in which there is no electrical connection with the contact point.
